(19) United States
(12) Patent Application Publication
(10) Pub. No.: US 2024/0296523 A1
(43) Pub. Date: Sep. 5, 2024

(54) METHOD FOR SEMANTIC IMAGE SYNTHESIS USING CONDITION DIFFUSION AND APPARATUS FOR SAME

(71) Applicant: Korea University Research and Business Foundation, Seoul (KR)

(72) Inventors: Hyunwoo KIM, Yongin-si (KR); Inho KONG, Yongin-si (KR); Juyeon KO, Anyang-si (KR)

(21) Appl. No.: 18/591,173

(22) Filed: Feb. 29, 2024

(30) Foreign Application Priority Data
Mar. 2, 2023 (KR) 10-2023-0027952

(51) Int. Cl. G06T 5/60; G06T 5/73

(52) U.S. Cl. CPC G06T 5/60; G06T 5/73; G06T 2207/20081

(57) ABSTRACT

A semantic image generation method using condition image diffusion according to an embodiment of the present invention includes the steps of: (a) training an image generation model by inputting N-th learning data (N is a random positive integer); (b) inputting input data for generating semantic images into the trained image generation model; and (c) outputting one or more semantic images generated by the image generation model according to the input data, wherein the input data includes a condition image frame (Layout), which is input condition data, and the condition image frame is an image frame, through which classes, which are one or more objects included in a semantic image to be generated, are classified into each category by the object, and a different number is assigned to pixel areas occupied by the classes for each classified category.

### CROSS-REFERENCE TO RELATED APPLICATIONS

This application claims the benefit of Korean Patent Application No. 10-2023-0027952, filed on Mar. 2, 2023, in the Korean Intellectual Property Office, the disclosure of which is incorporated herein by reference in its entirety.

### TECHNICAL FIELD

The present invention relates to a method of generating semantic images using condition image diffusion and an apparatus for the same, and more specifically, to a method that allows an image generation model based on artificial intelligence, which receives only an image frame, to generate a variety of high-quality images matching the image frame, and an apparatus for the same.

### BACKGROUND ART

A semantic image generation technique refers to a technique of generating, when information on an object included in an image is given in pixel units in an area occupied by the object, i.e., when a kind of image frame is given, an appropriate image matching the image frame (here, generation includes the meaning of synthesis).

In relation thereto, conventional semantic image generation techniques apply a Generative Adversarial Network (GAN) as an image generation model in most cases, and the Generative Adversarial Network is a neural network configured of a generation model (generator) and a discrimination model (discriminator). The generation model learns to generate fake images that look like a real image to make it difficult for the discrimination model to distinguish the real image from the fake images imitating the real image, and the discrimination model is a model of which the overall performance can be improved as learning is individually proceeded to accurately distinguish the real image from the fake images generated by the generation model to look like the real image. Although the images generated through the Generative Adversarial Network have good quality and excellent performance, they have disadvantages in that the learning process is unstable and vulnerable to a mode collapse phenomenon.

Meanwhile, a number of new models have been developed recently to overcome the disadvantages of the Generative Adversarial Network, and among these, the diffusion model is spotlighted particularly. The diffusion model is a model that trains a model by adding noise to data little by little and then generates new data by removing the noise in a reverse direction, and since its performance is superior to that of the Generative Adversarial Network, attempts of applying the diffusion model in various fields are continued.

The present invention applies the diffusion model as an image generation model of the semantic image generation technique, and proposes a method of generating a variety of high-quality images by improving performance to a level of applying the diffusion model beyond the level of simply employing the diffusion model, and an apparatus for the same.

### PATENT DOCUMENTS

Korean Patent Publication No. 10-2021-0040881 (2021 Apr. 14)

### DISCLOSURE OF INVENTION

### Technical Problem

Therefore, the present invention has been made in view of the above problems, and it is an object of the present invention to provide a method of generating semantic images using condition image diffusion, which allows stable learning by applying a diffusion model as an image generation model of a semantic image generation technique, and an apparatus for the same.

Another object of the present invention is to provide a method of generating semantic using condition image diffusion, which can generate a variety of high-quality images by applying a diffusion model as an image generation model of a semantic image generation technique, and an apparatus for the same.

Still another object of the present invention is to provide a method of generating semantic images using condition image diffusion, which applies a diffusion model as an image generation model based on artificial intelligence, and may generate images even for image frames that the model encounters for the first time, and an apparatus for the same.

The technical problems of the present invention are not limited to the technical problems mentioned above, and other unmentioned technical problems will be clearly understood by those skilled in the art from the following description.

### Technical Solution

To accomplish the above objects, according to one aspect of the present invention, there is provided a method of generating semantic images using condition image diffusion, by an apparatus including a processor and a memory, the method comprising the steps of: (a) training an image generation model by inputting N-th learning data (N is a random positive integer); (b) inputting input data for generating semantic images into the trained image generation model; and (c) outputting one or more semantic images generated by the image generation model according to the input data, wherein the input data includes a condition image frame (Layout), which is input condition data, and through the condition image frame, classes, which are one or more objects included in a semantic image to be generated, are classified into each category by the object, and a different number is assigned to pixel areas occupied by the classes for each classified category.

According to an embodiment, step (a) may include the steps of: (a-1) generating N′-th learning data by adding noise to the N-th learning data through selection of any one among first to fourth noise addition methods; (a-2) predicting noise applied to the N′-th learning data by inputting the generated N′-th learning data into the image generation model; and (a-3) comparing the noise added at step (a-1) with the noise predicted at step (a-2), setting a difference thereof as a loss function, and learning by applying gradient descent.

According to an embodiment, step (a) may further include the steps of: (a-4) determining whether the set loss function converges to a minimum value; (a-5) returning to step (a-1) when a result of the determination at step (a-4) is NO; and (a-6) terminating learning of the image generation model when the result of the determination at step (a-5) is YES.

According to an embodiment, the N-th learning data may be an N-th real image, and in this case, the first noise addition method may be a noise addition method that has no correlation with a previous time (Timestep) according to Equation 1 shown below. Equation 1: q(xₜ|x₀)= [symbol] (xₜ;\sqrt{α̅ₜ}x₀,(1−α̅ₜ)I) Here, xₜ denotes the N-th real image added with noise at an arbitrary time point t, x₀ denotes the N-th real image of an initial state before noise is added, αₜ=1−βₜ, α̅ₜ: Πₛ₌₁^{t}αₛ, βₜ denotes a noise schedule at an arbitrary time point t, and I denotes a unit matrix.

According to an embodiment, the N-th learning data may be an N-th real image, and in this case, the second noise addition method may be a noise addition method that has a direct correlation with a previous time (Timestep) according to Equation 2 shown below. Equation 2: q(xₜ|xₜ₋₁)= [symbol] (xₜ; \sqrt{1−βₜ}xₜ₋₁, βₜI) Here, xₜ denotes the N-th real image added with noise at an arbitrary time point t, xₜ₋₁ denotes the N-th real image added with noise at t−1, which is a time point immediately before the arbitrary time point t, βₜ denotes a noise schedule at an arbitrary time point t, and I denotes a unit matrix.

According to an embodiment, the N-th learning data may be an N-th real image, and in this case, the third noise addition method may be a noise addition method that has a direct correlation with a previous time (Timestep) according to Equation 3 shown below. Equation 3: q(xₜ|xₜ₋₁):= [symbol] (xₜ; \sqrt{1−βₜ}xₜ₋₁, 0) Here, xₜ denotes the N-th real image added with noise at an arbitrary time point t, xₜ₋₁ denotes the N-th real image added with noise at t−1, which is a time point immediately before the arbitrary time point t, βₜ denotes a noise schedule at an arbitrary time point t, and I denotes a unit matrix.

According to an embodiment, the N-th learning data may be an N-th real image, and in this case, the fourth noise addition method may be a noise addition method that has a direct correlation with a previous time (Timestep) according to Equation 4 shown below.

$${q}_{σ} ( {x}_{t - 1} \vert {x}_{t} , {x}_{0} ) = 𝒩 ( \sqrt{{α}_{t - 1}} {x}_{0} + \sqrt{1 - {α}_{t - 1} - {σ}_{t}^{2}} \cdot \frac{{x}_{t} - \sqrt{{α}_{t}} {x}_{0}}{\sqrt{1 - {α}_{t}}} , {σ}_{t}^{2} I ) \qquad Equation 4$$

Here, xₜ₋₁ denotes the N-th real image added with noise at t−1, which is a time point immediately before an arbitrary time point t, xₜ denotes the N-th real image added with noise at an arbitrary time point t, x₀ denotes the N-th real image of an initial state before noise is added, αₜ=1−βₜ, α̅ₜ: Πₛ₌₁^{t}αₛ, βₜ denotes a noise schedule at an arbitrary time point t, σ is a standard deviation set at each time t, and I denotes a unit matrix.

According to an embodiment, the N-th learning data may be an N-th real image, and in this case, step (a-2) may include the steps of: (a-2-1) inputting the generated N′-th learning data into the image generation model; (a-2-1) inputting N-th input condition data, which is obtained by adding noise to an N-th condition image frame corresponding to the N-th real image through any one among the first to fourth noise addition methods, into the image generation model; and (a-2-3) predicting noise applied to the N′-th learning data by reflecting the input N-th input condition data.

According to an embodiment, step (b) may include the steps of: (b-1) randomly generating noise data of a size the same as that of the semantic image desired to be generated, and inputting the noise data into the image generation model as input data; and (b-2) generating input condition data by adding noise to a condition image frame for generating a semantic image through any one of the first to fourth noise addition methods, and inputting the input condition data into the image generation model.

According to an embodiment, the image generation model includes an encoder unit and a decoder unit, and may further include a condition image frame utilization unit including one or more convolution layers that acquire feature values from the condition image frame and calculate a scale value and a bias value by passing the feature values, wherein the calculated scale value and bias value may be acquired from the input data, and input into the batch normalized feature values to be calculated.

According to another aspect of the present invention, there is provided an apparatus for generating semantic images using condition image diffusion, the apparatus comprising: one or more processors; a network interface; a memory for loading a computer program executed by the processors; and a storage for storing large-capacity network data and the computer program, wherein the computer program executes (A) an operation of training an image generation model by inputting N-th learning data (N is a random positive integer), (B) an operation of inputting input data for generating semantic images into the trained image generation model, and (C) an operation of outputting one or more semantic images generated by the image generation model according to the input data by the one or more processors, wherein the input data is a condition image frame (Layout) corresponding to an input condition, and through the condition image frame, classes, which are one or more objects included in a semantic image to be generated, are classified into each category by the object, and a different number is assigned to pixel areas occupied by the classes for each classified category.

According to another aspect of the present invention, there is provided a computer program stored in a computer-readable medium, the program for executing the steps of: (AA) training the image generation model by inputting N-th learning data (N is a random positive integer); (BB) inputting input data for generating semantic images into the trained image generation model; and (CC) outputting one or more semantic images generated by the image generation model according to the input data, in combination with a computing device, wherein the input data is a condition image frame (Layout) corresponding to an input condition, and through the condition image frame, classes, which are one or more objects included in a semantic image to be generated, are classified into each category by the object, and a different number is assigned to pixel areas occupied by the classes for each classified category.

### Advantageous Effects

According to the present invention as described above, as a diffusion model is applied as an image generation model of an image generation technique, and learning is proceeded by appropriately selecting any one among first to fourth noise addition methods considering factors such as reduction of burdens on memory resources, computation time, and the like in real time, there is an effect of allowing stable learning and generating high-quality images at the same time.

In addition, as a variety of semantic images can be generated for one input data by solving the problem of the prior art that lowers diversity of generated semantic images due to a mode collapse phenomenon, there is an effect of securing diversity of resulting products.

In addition, as a diffusion process of proceeding learning while adding noise even to a condition image frame corresponding to an input condition is performed, there is an effect in that an image generation model may accept input conditions more effectively and generate a variety of high-quality semantic images even for image frames encountered for the first time.

The effects of the present invention are not limited to the effects mentioned above, and other unmentioned effects will be clearly understood by those skilled in the art from the following description.

### BRIEF DESCRIPTION OF THE DRAWINGS

FIG. 1 is a view showing the overall configuration of a semantic image generation apparatus using condition image diffusion according to a first embodiment of the present invention.

FIG. 2 is a flowchart illustrating representative steps of a semantic image generation method using condition image diffusion according to a second embodiment of the present invention.

FIG. 3 is a flowchart specifying step S210 of training an image generation model in a semantic image generation method using condition image diffusion according to a second embodiment of the present invention.

FIG. 4 is a view exemplarily showing a mimetic view of a first noise addition method.

FIG. 5 is a view exemplarily showing a mimetic view of a second noise addition method.

FIG. 6 is a view exemplarily showing a mimetic view of a third noise addition method.

FIG. 7 is a view exemplarily showing a mimetic view of a fourth noise addition method (a case where σ is not 0).

FIG. 8 is a view exemplarily showing a mimetic view of a fourth noise addition method (a case where σ is 0).

FIG. 9 is a view exemplarily showing a condition image frame, which is an input condition input into a diffusion model.

FIG. 10 is a view exemplarily showing a semantic image generated by inputting the condition image frame shown in FIG. 9 into an image generation model, together with the condition image frame.

FIG. 11 is a view exemplarily showing the structure of U-Net, which is a conventional image generation model.

FIG. 12 is a view exemplarily showing the structure of Y-Net, which is the structure of an image generation model proposed in the present invention.

### BEST MODE FOR CARRYING OUT THE INVENTION

Details of the objects and technical configurations of the present invention and operational effects according thereto will be more clearly understood by the following detailed description based on the drawings attached in the specification of the present invention. Embodiments according to the present invention will be described in detail with reference to the accompanying drawings.

The embodiments disclosed in this specification should not be construed or used as limiting the scope of the present invention. For those skilled in the art, it is natural that the description including the embodiments of the present specification have a variety of applications. Accordingly, arbitrary embodiments described in the detailed description of the present invention are illustrative for better description of the present invention, and are not intended to limit the scope of the present invention to the embodiments.

The functional blocks shown in the drawings and described below are only examples of possible implementations. Other functional blocks may be used in other implementations without departing from the spirit and scope of the detailed description. In addition, although one or more functional blocks of the present invention are expressed as separate blocks, one or more of the functional blocks of the present invention may be combinations of various hardware and software configurations that perform the same function.

In addition, expressions including certain components are expressions of “open type” and only refer to existence of corresponding components, and should not be construed as excluding additional components.

Furthermore, when a certain component is referred to as being “connected” or “coupled” to another component, it may be directly connected or coupled to another component, but it should be understood that other components may exist in the middle.

Hereinafter, detailed embodiments of the present invention will be described with reference to the drawings.

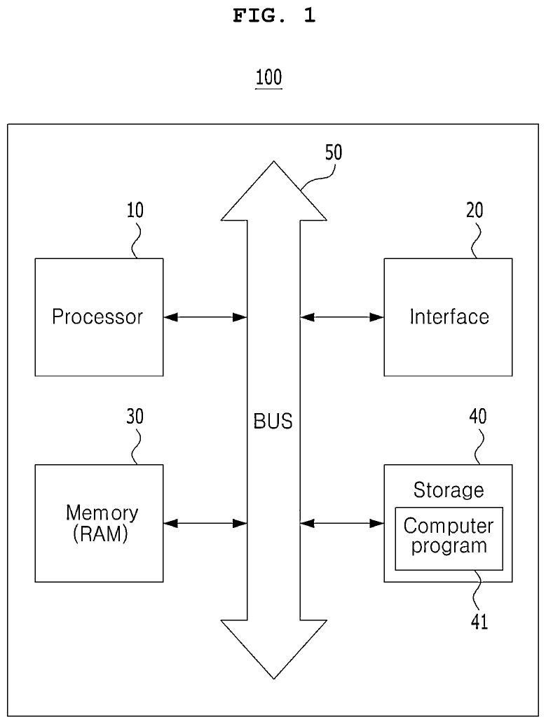

FIG. 1 is a view showing the overall configuration of a semantic image generation apparatus 100 using condition image diffusion according to a first embodiment of the present invention.

However, this is only a preferred embodiment for accomplishing the objects of the present invention, and some components may be added or deleted as needed, and it goes without saying that a function performed by any one component may be performed together with another component.

A semantic image generation apparatus 100 using condition image diffusion according to a first embodiment of the present invention may include a processor 10, a network interface 20, a memory 30, a storage 40, and a data bus 50 connecting them, and it goes without saying that the apparatus 100 may further include additional components required to accomplish the objects of the present invention.

The processor 10 controls the overall operation of each component. The processor 10 may be a central processing unit (CPU), a microprocessor unit (MPU), a micro controller unit (MCU), or any one of artificial intelligence processors of a type widely known in the technical field of the present invention. In addition, the processor 10 may perform operation of at least one application or program for performing a semantic image generation method using condition image diffusion according to a second embodiment of the present invention, and to this end, the processor 10 may include an image generation model based on a diffusion model representing a predetermined structure, and this will be described below.

The network interface 20 supports wired and wireless Internet communication of the semantic image generation apparatus 100 using condition image diffusion according to a first embodiment of the present invention, and may also support other known communication methods. Accordingly, the network interface 20 may be configured to include a communication module corresponding thereto.

The memory 30 may store various types of data, commands, and/or information, and may load one or more computer programs 41 from the storage 40 to perform the semantic image generation method using condition image diffusion according to a second embodiment of the present invention. Although RAM is shown as a kind of the memory 30 in FIG. 1, it goes without saying that various types of storage media may be used as the memory 30.

The storage 40 may store one or more computer programs 41 and large-capacity network information 42 in a non-temporary manner. The storage 40 may be any one among non-volatile memory such as Read Only Memory (ROM), Erasable Programmable ROM (EPROM), Electrically Erasable Programmable ROM (EEPROM), flash memory, or the like, hard disk drive (HDD), Solid State Drive (SSD), detachable disk, or computer-readable recording medium of an arbitrary form widely known in the technical field of the present invention.

The computer program 41 is loaded on the memory 30 and may execute, by one or more processors 10, (A) an operation of training an image generation model by inputting N-th learning data (N is a random positive integer), (B) an operation of inputting input data for generating semantic images into the trained image generation model, and (C) an operation of outputting one or more semantic images generated by the image generation model according to the input data.

The operations performed by the computer program 41 briefly mentioned above may be viewed as a function of the computer program 41, and a more detailed description will be provided below in the description of the semantic image generation method using condition image diffusion according to a second embodiment of the present invention.

The data bus 50 functions as a passage of commands and/or information between the processor 10, the network interface 20, the memory 30, and the storage 40 described above.

The semantic image generation apparatus 100 using condition image diffusion according to a first embodiment of the present invention described above briefly may be in a form of an independent device, e.g., a form of an electronic device or a server (including cloud), and here, since the electronic device may include portable devices that are easy to carry, such as smartphones, tablet PCs, laptop PCs, PDAS, PMPs, and the like, as well as devices such as desktop PCs and server devices that are fixedly installed and used in a place, it may be any electronic device having a network function, provided that a CPU or the like corresponding to the processor 10 is installed.

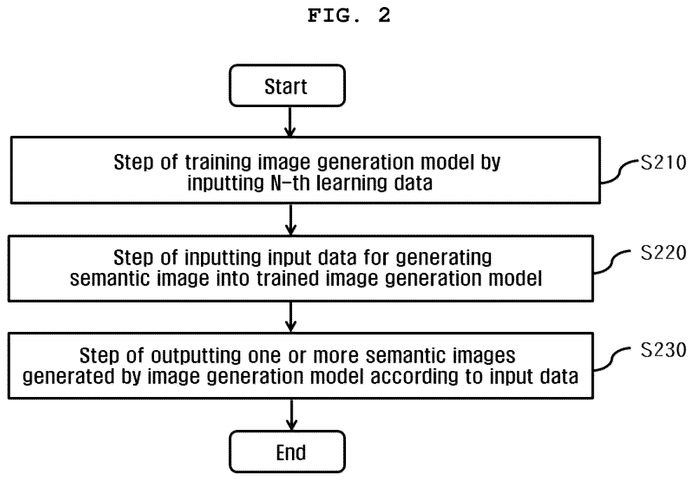

Hereinafter, a process of providing the semantic image generation method using condition image diffusion according to a second embodiment of the present invention through a dedicated application installed in a user terminal (not shown) of a user who desires to input an image frame and generate a semantic image corresponding thereto will be described with reference to FIGS. 2 to 11, on the assumption that the semantic image generation apparatus 100 using condition image diffusion according to a first embodiment of the present invention is in a form of a “server” among electronic devices, which are independent devices.

FIG. 2 is a flowchart illustrating representative steps of a semantic image generation method using condition image diffusion according to a second embodiment of the present invention.

However, this is only a preferred embodiment in accomplishing the objects of the present invention, and it goes without saying that some steps may be added or deleted as needed, and any one step may be performed to be included in another step.

Meanwhile, since it is assumed that each step is performed through the semantic image generation apparatus 100 using condition image diffusion according to a first embodiment of the present invention, and that the semantic image generation apparatus 100 using condition image diffusion according to a first embodiment of the present invention is in the form of a “server”, the dedicated application installed in the user terminal (not shown) will be viewed in the same sense as the semantic image generation apparatus 100 using condition image diffusion according to a first embodiment of the present invention, and all of these will be referred to as an “apparatus 100” for convenience of explanation.

First, the apparatus 100 trains the image generation model by inputting N-th learning data (S210) (N is a random positive integer).

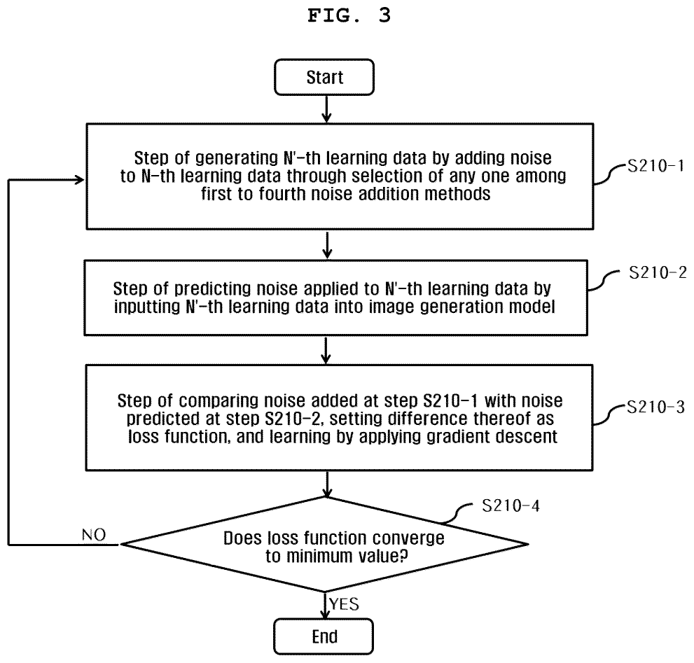

Here, the image generation model means an image generation model based on a diffusion model, and hereinafter, step S210 will be described in more detail with reference to FIG. 3.

FIG. 3 is a flowchart specifying step S210 of training an image generation model in a semantic image generation method using condition image diffusion according to a second embodiment of the present invention.

However, this is only a preferred embodiment in accomplishing the objects of the present invention, and it goes without saying that some steps may be added or deleted as needed, and any one step may be performed to be included in another step.

First, the apparatus 100 generates N′-th learning data by adding noise to the N-th learning data through selection of any one among the first to fourth noise addition methods (S210-1).

Here, the N-th learning data may be an N-th real image, which is a real image, and for example, when the semantic image to be generated through the image generation model is a human face image, the N-th real image may be a human face image.

Meanwhile, the semantic image generation method using condition image diffusion according to a second embodiment of the present invention has singularity in the noise addition method compared to a method of adding noise for learning in a universal diffusion model, and this is first to fourth noise addition methods.

Setting the prerequisite conditions of description before describing the methods in detail, the first to fourth noise addition methods may vary according to a method of adding noise to N-th real image at an arbitrary time t, more specifically, how to design a mathematical equation for obtaining data (x_t or y_t) at an arbitrary intermediate time (Timestamp) t. The time is set to 0, 1, 2, . . . , (T−2), (T−1), T in the learning process, and time changes as T, (T−1), (T−2) . . . 2, 1, 0 in the inference process. In addition, the N-th real image is in the form of an original image (or a generated image in a sampling or inference process) at time 0 and in the form of complete noise at time T, and the noise schedule about how much noise will be added at each time (Timestamp) is set to β₁, β₂, β₃ . . . βₜ . . . β_{T-1}, β_{T}.

The first noise addition method is a noise addition method that has no correlation with a previous time (Timestep) according to Equation 1 shown below.

$$q ( {x}_{t} \vert {x}_{0} ) = 𝒩 ( {x}_{t} ; \sqrt{{\overline{α}}_{t}} {x}_{0} , ( 1 - {\overline{α}}_{t} ) I ) \qquad Equation 1$$

Here, xₜ denotes the N-th real image added with noise at an arbitrary time point t, x₀ denotes the N-th real image of the initial state before noise is added, αₜ=1−βₜ, α̅ₜ: Πₛ₌₁^{t}αₛ, βₜ denotes the noise schedule at an arbitrary time point t, and I denotes a unit matrix.

Although the first noise addition method is similar to a method of adding noise when learning is proceeded in a universal diffusion model, this new method is defined in the present invention since the condition image diffusion method of adding noise to a condition image frame while proceeding inference on a trained image generation model does not exist in the prior art, as will be explained below in the description of the N-th condition image frame, unlike adding noise in the learning process of the image generation model for generating semantic images.

Meanwhile, since the first noise addition method has no direct correlation with the previous time as can be confirmed in Equation 1 and is calculated only using the original data and the noise schedule, the explicit relationship between the (noised) real images may be insufficient in each process of adding noise to a real image, and this may lead to degradation in the quality of the generated semantic images. However, since a condition image frame added with noise can be calculated immediately at the time only by putting a real image corresponding to the original data into Equation 1, it is very advantageous in terms of utilizing the time and memory of the apparatus 100.

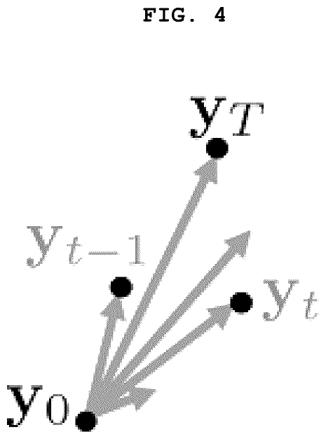

A mimetic view of the first noise addition method is exemplarily shown in FIG. 4, and as y₀, yₜ₋₁, yₜ, y_{T} are all facing individual directions without being connected, it can be confirmed that there is no direct correlation with the previous time, and accordingly, the first noise addition method is named as Jump Noising.

The second noise addition method is a noise addition method that has a direct correlation with the previous time (Timestep) according to Equation 2 shown below.

$$q ( {x}_{t} \vert {x}_{t - 1} ) = 𝒩 ( {x}_{t} ; \sqrt{1 - {β}_{t}} {x}_{t - 1} , {β}_{t} I ) \qquad Equation 2$$

Here, xₜ denotes the N-th real image added with noise at an arbitrary time point t, xₜ₋₁ denotes the N-th real image added with noise at t−1, which is a time point immediately before the arbitrary time point t, βₜ denotes the noise schedule at an arbitrary time point t, and I denotes a unit matrix.

As can be confirmed in Equation 2, the second noise addition method is a method of generate data of the next time having a direct correlation with adjacent times, more specifically, by directly utilizing data of the previous time, and since the data at each time has a close relationship with the previous and subsequent times, generated semantic images may be guided more precisely and accurately by the real image added with noise, and therefore, semantic images of further higher quality can be generated.

However, unlike the first noise addition method, which only needs the original data, i.e., the N-th real image of the initial state, since the second noise addition method should input a real image added with noise appropriate to each time into the image generation model in order, all data added with noise at each time should be stored in the memory, and therefore, a burden of a predetermined level or higher may be imposed on the memory resources of the apparatus 100.

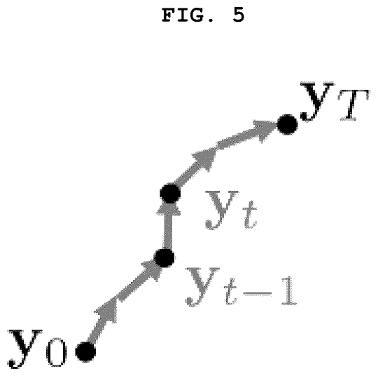

A mimetic view of the second noise addition method is exemplarily shown in FIG. 5, and since y₀, yₜ₋₁, yₜ, y_{T} are connected as one although the facing directions are different, it can be confirmed that there is a direct correlation with the previous time, and accordingly, the second noise addition method is named as Ancestral Noising.

The third noise addition method is a noise addition method that has a direct correlation with the previous time (Timestep) according to Equation 3 shown below.

$$q ( {x}_{t} \vert {x}_{t - 1} ) := 𝒩 ( {x}_{t} ; \sqrt{1 - {β}_{t}} {x}_{t - 1} , 0 ) \qquad Equation 3$$

Here, xₜ denotes the N-th real image added with noise at an arbitrary time point t, xₜ₋₁ denotes the N-th real image added with noise at t−1, which is a time point immediately before the arbitrary time point t, βₜ denotes the noise schedule at an arbitrary time point t, and I denotes a unit matrix.

The third noise addition method is based on Equation 2 like the second noise addition method, and this is a method that uses only the average term excluding the standard deviation (covariance) term (treated as 0) in the normal distribution expressed by Equation 2, which is a method of omitting the stochastic calculation that occurs due to the standard deviation and adding noise to the real image in the average term, i.e., in a direction expected to have the highest probability, while maintaining the closer correlation between adjacent times, which is the advantage of the second noise addition method. Therefore, since the third noise addition method uses only the average term and does not need to store all the data added with noise at each time in the memory like the second noise addition method, the burden that may occur on the memory resources of the apparatus 100 can be eliminated.

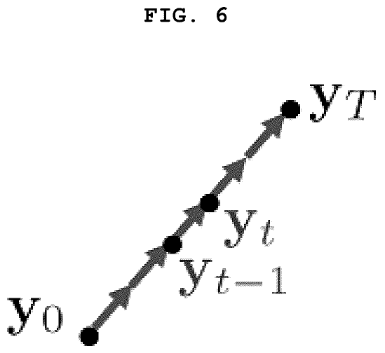

A mimetic view of the third noise addition method is exemplarily shown in FIG. 6, and since y₀, yₜ₋₁, yₜ, y_{T} face the same direction and are connected as one as the third noise addition method uses only the average term, it can be confirmed that there is a direct correlation with the previous time, and accordingly, the third noise addition method is named as Mean Noising.

Finally, the fourth noise addition method is a noise addition method that has a direct correlation with the previous time (Timestep) according to Equation 4 shown below.

A semantic image generation method using condition image diffusion.

$${q}_{σ} ( {x}_{t - 1} \vert {x}_{t} , {x}_{0} ) = 𝒩 ( \sqrt{{α}_{t - 1}} {x}_{0} + \sqrt{1 - {α}_{t - 1} - {σ}_{t}^{2}} \cdot \frac{{x}_{t} - \sqrt{{α}_{t}} {x}_{0}}{\sqrt{1 - {α}_{t}}} , {σ}_{t}^{2} I ) \qquad Equation 4$$

Here, xₜ₋₁ denotes the N-th real image added with noise at t−1, which is a time point immediately before an arbitrary time point t, xₜ denotes the N-th real image added with noise at an arbitrary time point t, x₀ denotes the N-th real image of the initial state before noise is added, αₜ=1−βₜ, α̅ₜ: Πₛ₌₁^{t}αₛ, βₜ denotes the noise schedule at the arbitrary time point t, σ denotes the standard deviation set at each time t, and I denotes a unit matrix.

Equation 4 like this is an equation derived from q_{σ}(x_{T}|x₀)= [symbol] (\sqrt{α_{T}}x₀, (1−α_{T})I), it is not a Markovian process like in the universal diffusion model, and since σ is the standard deviation set at each time t, the larger the σ, the more stochastic the diffusion process (Forward Process), and the closer σ to 0, the more deterministic the diffusion process becomes.

That is, in Equation 4, σ may be individually set by the manager or the user of the apparatus 100, and as the stochastic calculation part is omitted in a way similar to the third noise addition method when the conversion process of each time becomes deterministic by setting σ to 0 for each time t, it does not need to store all the data added with noise at each time in the memory like the second noise addition method, and therefore, the burden that may occur on the memory resources of the apparatus 100 can be eliminated.

On the other hand, when σ is individually set for each time t, the conversion process of each time becomes stochastic, and thus the semantic image generated in a way similar to the second noise addition method can be guided more precisely and accurately by the real image added with noise, and therefore, higher quality semantic images can be generated. That is, the fourth noise addition method is a method that can be selectively provided with the advantage of the second noise addition method or the advantage of the third noise addition method according to setting of σ for each time t.

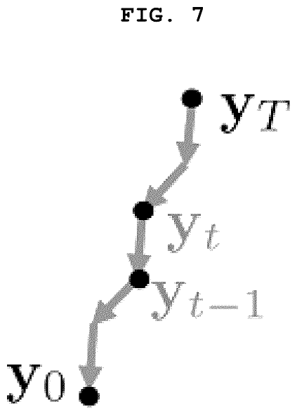

A mimetic view of the fourth noise addition method, more specifically, a case where σ is not 0, is exemplarily shown in FIG. 7, and after calculating y_{T} first, y_{T} to y₁ are calculated by repeating calculation of yₜ₋₁ from yₜ and y₀. As σ is not 0, it is stochastic, and therefore, since y_{T}, yₜ, yₜ₋₁, and y₀ are connected as one although the facing directions are different as shown in the case of FIG. 6, it can be confirmed that there is a direct correlation with the previous time.

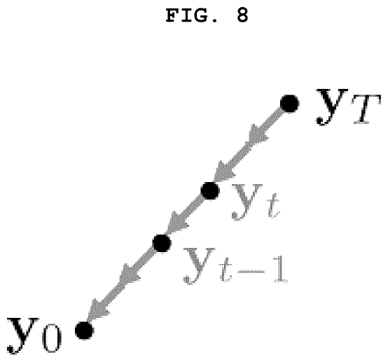

On the other hand, a mimetic view of the fourth noise addition method, more specifically, a case where σ is 0, is exemplarily shown in FIG. 8, and as σ is 0, it is deterministic, and therefore, since y_{T}, yₜ, yₜ₋₁, and y₀ face the same direction and are connected as one as shown in the case of FIG. 7, it can be confirmed that there is a direct correlation with the previous time. Accordingly, the fourth noise addition method is named as Denoising Diffusion Implicit Models (DDIM) Noising.

Four noise addition methods have been described above. The semantic image generation method using condition image diffusion according to a second embodiment of the present invention may effectively add noise to the N-th learning data by appropriately selecting any one among the first to fourth noise addition methods, considering first the quality of semantic images to be generated in the learning process and factors such as reduction of burdens on memory resources, computation time, and the like of the apparatus 100 in real time, and may secure diversity of semantic images to be generated by using various noise addition methods. In addition, even completeness of learning may be improved by allowing real-time switching between the four noise addition methods for one learning data, such as the first noise addition method at time t, the second noise addition method at time t+1, the third noise addition method at time t+3, and the like for the N-th learning data.

Now, FIG. 3 will be described again.

When the N′-th learning data is generated, the apparatus 100 predicts noise applied to the N′-th learning data by inputting the generated N′-th learning data into the image generation model (S210-2).

This is since that when the noise applied to the N′-th learning data is predicted and as much noise as predicted is removed from the N′-th learning data, the N-th learning data, which is the data before the noise is added, can be calculated, and as the first to fourth noise addition methods, which are the singularity of the present invention described above, may also be related to step S210-2, and this will be described below.

Step S210-2 of predicting noise may include the steps of: inputting N′-th learning data into the image generation model by the apparatus 100 (S210-2-1), inputting N-th input condition data, which is obtained by adding noise to an N-th condition image frame corresponding to the N-th real image, i.e., the N-th learning data, through any one among the first to fourth noise addition methods, into the image generation model (S210-2-2), and predicting noise applied to the N′-th learning data by reflecting the input N-th input condition data (S210-2-3), and the semantic image generation method using condition image diffusion according to a second embodiment of the present invention may enhance learning completeness and contribute to improving performance of the entire image generation model by adding noise even to the N-th condition image frame corresponding to the N-th real image, as well as the N-th real image, and inputting it into the image generation model during learning process.

Here, the condition image frame corresponds to the input condition (conditional input) of the diffusion model, and since classes, which are one or more objects included in a semantic image to be generated, are classified into each category by the object through the condition image frame, and a different number, for example, a number between 0 and 18 or even higher, may be assigned to the pixel areas occupied by the classes for each classified category, the condition image frame is also referred to as Semantic layout, Semantic map, Semantic condition, or the like.

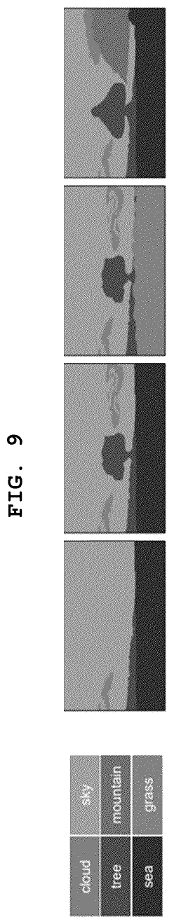

FIG. 9 exemplarily shows a condition image frame, which is an input condition input into a diffusion model, and as individual pixels assigned with a number are so small that it is difficult to display the pixels on the drawing, they are distinguished by different colors instead of the numbers for convenience of identification, and the cloud (grey), sky (light blue), tree (brown), mountain (blue green), sea (blue), and grass (green) in the leftmost part of the drawing may be regarded as corresponding to the classes (or categories), which are objects included in the semantic image to be generated through the condition image frame.

Observing the four drawings on the right side (referred to as drawings 1 to 4 in order) on the basis of the condition image frame, it can be confirmed that drawing 1 includes cloud, sky, tree, and sea as classes, drawing 2 includes cloud, sky, tree, and sea as classes, drawing 3 includes cloud, sky, tree, and grass as classes, and drawing 4 includes cloud, sky, tree, mountain, and sea as classes through the pixel area occupied by each class on the condition image frame, and a pixel area corresponding to each class corresponds to an area where an image of a real class generated through the image generation model will be generated.

Describing image number 4 as an example, an image of a real cloud is generated in the pixel area for the cloud class shown in gray, an image of a real sky is generated in the pixel area for the sky class shown in light blue, an image of a real tree is generated in the pixel area for the tree class shown in brown, an image of a real mountain is generated in the pixel area for the mountain class shown in blue green, and an image of a real sea is generated in the pixel area for the cloud sea shown in blue, and they are referred to as input conditions since they provide information on the area of the semantic image to be generated and information about which object (or class) should be generated in which area on the semantic image to be generated.

Since the condition image frame corresponds to the input condition, it is not a target to be added with noise, but is simply input, in the universal diffusion model. However, it has been recognized through the research of the present invention that there are various reasons for adding noise to the condition image frame that corresponds to the input condition. Specifically, although the condition image frame that is input to generate a semantic image is discrete data existing as many as the number of categories, in which the value itself of each pixel is an integer, the number of condition image frames themselves generated by combining the value of each pixel is almost infinite, and when a semantic image is actually generated (when sampling is performed), as a condition image frame that the image generation model has never seen before is input, it is highly required to construct a model robust to an unfamiliar condition. Therefore, the peculiar technical feature of the present invention of adding noise to the condition image frame is named as “condition image diffusion”, and the title of the present invention is named using the name.

Since the reason for adopting the process of adding noise, i.e., performing diffusion, in the diffusion model is to solve the problem that learning is not properly performed on data of a low probability value in the input data distribution, more specifically, the problem that learning is not properly performed since a loss function value for learning is set low for data of a low probability value. When noise is added to the data, and an appropriate amount of the noise is dispersed, data of a low probability value is reduced, and the problem of learning the area can be alleviated, and therefore, the present invention determines that the point where the diffusion model shows the effect and the characteristics of the condition image frame are in the same context in generating the semantic image described above, and innovatively incorporates even the condition image frame corresponding to the input condition into the target of adding noise.

Accordingly, the first to fourth noise addition methods, which are the four peculiar methods of adding noise to the N-th real image, i.e., the N-th learning data described above, may be equally applied to the N-th condition image frame. At this point, since it is sufficient to change the portion corresponding to the real image in each equation to the condition image frame, detailed description thereof will be omitted to prevent duplicated description.

Now, FIG. 3 will be described again.

When noise applied to the N′-th learning data is predicted, the apparatus 100 compares the noise added at step S210-1 with the noise predicted at step S210-2, sets a difference thereof as a loss function, and learns by applying gradient descent (S210-3).

As the noise is added to the N-th learning data at step S210-1, the apparatus 100 has information on how much noise is added, and when the noise predicted at step S210-2 using the added noise as correct answer noise is referred to as prediction noise, the loss function here may be set as |(correct answer noise)−(prediction noise)|².

The gradient descent applied to the set loss function is an exemplary deep learning theory used at step S210-3, and more specifically, this is a deep learning theory as a method of reducing the loss function by changing the slope of the loss function, which reduces the error by converging the slope through a process of obtaining a slope for the initial time point and moving in the opposite direction of the slope. As the loss function will gradually converge to the minimum value through application of the gradient descent, and the difference between the correct answer noise and the predicted noise will decrease accordingly, it will be a learning theory optimized to the semantic image generation method using condition image diffusion according to a second embodiment of the present invention, but it is not necessarily limited thereto, and it goes without saying that other known learning theories may be applied.

Meanwhile, as the gradient descent is applied, the steps of determining whether the set loss function converges to the minimum value (S210-4), returning to step S210-1 when a result of the determination at step S210-4 is NO, and terminating learning of the image generation model when the result of the determination at step S210-4 is YES may be performed after step S210-3.

Now, FIG. 2 will be described again.

When learning of the image generation model is completed, the apparatus 100 inputs input data for generating semantic images into the trained image generation model (S220).

Step S220 corresponds to the starting step when a semantic image is actually generated (when sampling or inference is performed) after learning of the image generation model is completed, and in the semantic image generation method using condition image diffusion according to a second embodiment of the present invention, the input data input for this purpose may include data that has randomly generated noise data of a size the same as that of the semantic image desired to be generated and a condition image frame corresponding to input condition data.

In addition, as the semantic image generation method using condition image diffusion according to a second embodiment of the present invention adds noise, when a semantic image is actually generated, even to the condition image frame for generating the semantic image, which is input condition data included in the input data, and inputs the condition image frame into the image generation model, the method has singularity of the noise addition method, and this is to improve the quality of the semantic image that will be generated by intentionally making a state the same as that of the learning process for the input data. Accordingly, step S220 may include a step of randomly generating noise data of a size the same as that of the semantic image that the apparatus 100 desires to generate (here, the noise data is random but complete noise data (time point T) and may be sampled from the Gaussian noise distribution), and inputting the noise data into the image generation model as input data (S220-1), and a step of generating input condition data by adding noise to a condition image frame for generating a semantic image through any one of the first to fourth noise addition methods, and inputting the input condition data into the image generation model (S220-2).

Meanwhile, according to the input data, the image generation model predicts how much noise is applied to the input data as is learned in the learning process at step S210, removes as much noise as predicted from input data, generates input data at time point T−1 by adding noise corresponding to time point T−1 to the input data from which noise is removed according to a noise schedule, and inputs again the input data into the image generation model, and the input data finally generated by repeating this process at time points T−2, T−3, . . . 2, 1, and 0 is output as the final semantic image.

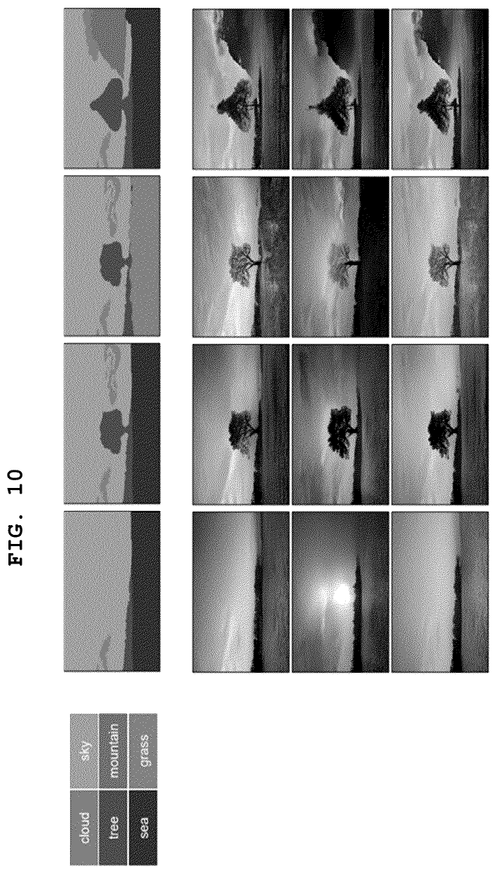

This process is referred to as an inference process, and FIG. 10 exemplarily shows a semantic image generated by inputting the condition image frame shown in FIG. 9 into an image generation model, together with the condition image frame. Referring to FIG. 10, it can be confirmed that images of the real cloud, sky, tree, mountain, sea, and grass generated by the image generation model are filled in the pixel areas occupied by the cloud (gray), sky (light blue), tree (brown), mountains (blue green), sea (blue), and grass (green) corresponding to the classes in the condition image frame, and it can be confirmed that a plurality of semantic images is generated in various ways for one condition image frame.

Until now, the semantic image generation method using condition image diffusion according to a second embodiment of the present invention has been described. According to the present invention, as a diffusion model is applied as an image generation model of an image generation technique, and learning is proceeded by appropriately selecting any one among first to fourth noise addition methods considering factors such as reduction of burdens on memory resources, computation time, and the like of the apparatus 100 in real time, stable learning is allowed and high-quality images can be generated at the same time. In addition, as a variety of semantic images can be generated for one input data by solving the problem of the prior art that lowers diversity of generated semantic images due to a mode collapse phenomenon, diversity of resulting products can be secured. In addition, as a diffusion process of proceeding learning while adding noise even to a condition image frame corresponding to input condition data is performed, an image generation model may accept input conditions more effectively and generate a variety of high-quality semantic images even for image frames encountered for the first time.

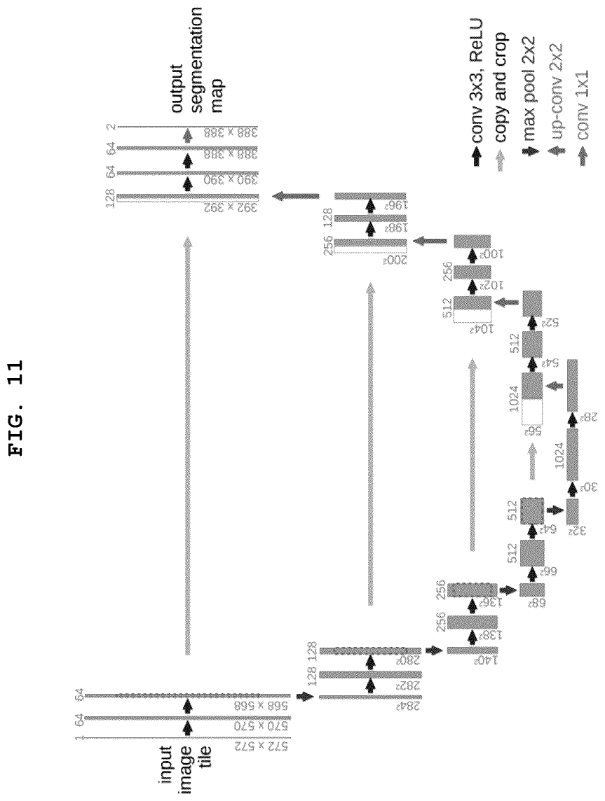

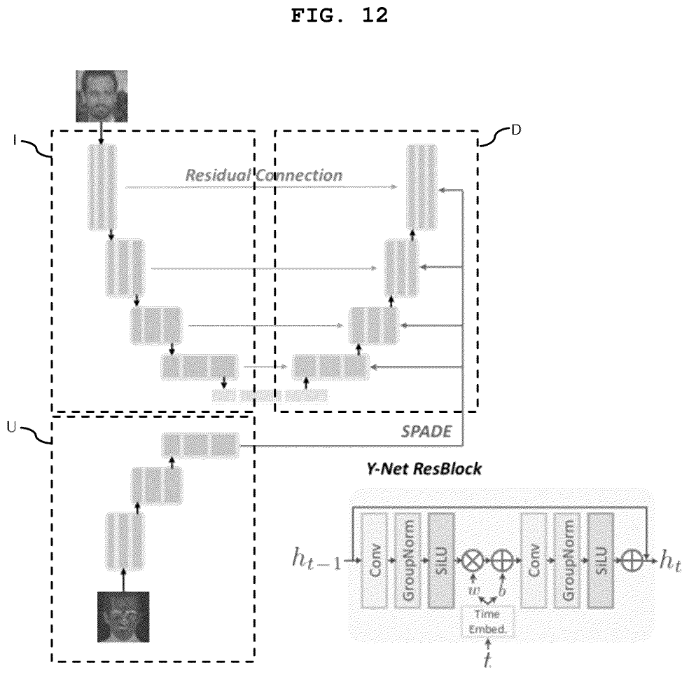

FIG. 11 exemplarily shows the structure of U-Net, which is a conventional image generation model, and FIG. 12 exemplarily shows the structure of the image generation model mentioned in the semantic image generation apparatus 100 using condition image diffusion according to a first embodiment of the present invention and the semantic image generation method using condition image diffusion according to a second embodiment of the present invention. Referring to FIG. 12, it can be confirmed that the image generation model of the present invention includes an encoder unit I and a decoder unit D, and further includes a condition image frame utilization unit U including one or more convolution layers that acquire feature values from the condition image frame and calculate a scale value and a bias value by passing the feature values.

Seeing only the encoder unit I and decoder unit D, it is the same as the structure of U-Net shown in FIG. 11. However, the image generation model of the present invention performs a diffusion process even on a condition image frame corresponding to the input condition and thus further includes an image frame utilization unit U that can reflect singularity according thereto. Accordingly, as the overall structure is similar to Y, this is named as Y-Net and newly proposed, and as the scale value and the bias value calculated by the image frame utilization unit U may be acquired from the input data, and input into the batch normalized feature values to be calculated, this may be regarded as applying a SPatially-Adaptive DEnormalization (SPADE) method, saying easily, a technique of injecting semantic information about the condition image frame into the feature vector in a normalization method by utilizing the condition image frame, in accordance with the characteristics of the present invention.

Finally, the semantic image generation apparatus 100 using condition image diffusion according to a first embodiment of the present invention and the semantic image generation method using condition image diffusion according to a second embodiment of the present invention may also be implemented as a computer program stored in a computer-readable medium according to a third embodiment of the present invention. In this case, (AA) a step of training the image generation model by inputting N-th learning data (N is a random positive integer), (BB) a step of inputting input data for generating semantic images into the trained image generation model, and (CC) a step of outputting one or more semantic images generated by the image generation model according to the input data may be executed in combination with a computing device. Although it is not described in detail for duplicated description, it goes without saying that all technical features applied to the semantic image generation apparatus 100 using condition image diffusion according to a first embodiment of the present invention and the semantic image generation method using condition image diffusion according to a second embodiment of the present invention may be equally applied to the computer program stored in a computer-readable medium according to a third embodiment of the present invention.

Although the embodiments of the present invention have been described above with reference to the accompanying drawings, those skilled in the art may understand that the present invention can be implemented in other specific forms without changing the technical spirit or essential features. Therefore, the embodiments described above should be understood as illustrative and not restrictive in all respects.

### DESCRIPTION OF SYMBOLS

10: Processor
11: First network
12: Second network
20: Network interface
30: Memory
40: Storage
41: Computer program
50: Information Bus
100: Apparatus for generating semantic images using condition
image diffusion
I: Encoder section
D: Decoder unit
U: Condition image frame utilization unit

1. A method of generating semantic images using condition image diffusion, by an apparatus including a processor and a memory, the method comprising the steps of:
(a) training an image generation model by inputting N-th learning data (N is a random positive integer);
(b) inputting input data for generating semantic images into the trained image generation model; and
(c) outputting one or more semantic images generated by the image generation model according to the input data, wherein
the input data is a condition image frame (Layout) corresponding to an input condition, and through the condition image frame, classes, which are one or more objects included in a semantic image to be generated, are classified into each category by the object, and a different number is assigned to pixel areas occupied by the classes for each classified category.

2. The method according to claim 1, wherein step (a) includes the steps of:
(a-1) generating N′-th learning data by adding noise to the N-th learning data through selection of any one among first to fourth noise addition methods;
(a-2) predicting noise applied to the N′-th learning data by inputting the generated N′-th learning data into the image generation model; and
(a-3) comparing the noise added at step (a-1) with the noise predicted at step (a-2), setting a difference thereof as a loss function, and learning by applying gradient descent.

3. The method according to claim 2, further comprising, after step (a-3), the steps of:
(a-4) determining whether the set loss function converges to a minimum value;
(a-5) returning to step (a-1) when a result of the determination at step (a-4) is NO; and
(a-6) terminating learning of the image generation model when the result of the determination at step (a-4) is YES.

4. The method according to claim 2, wherein the N-th learning data is an N-th real image, and in this case, the first noise addition method is a noise addition method that has no correlation with a previous time (Timestep) according to Equation 1 shown below, Equation 1: q(xₜ|x₀)= [symbol] (xₜ; \sqrt{α̅ₜ}x₀, (1−α̅ₜ)I), wherein xₜ denotes the N-th real image added with noise at an arbitrary time point t, x₀ denotes the N-th real image of an initial state before noise is added, αₜ=1−βₜ, α̅ₜ: Πₛ₌₁^{t}αₛ, βₜ denotes a noise schedule at an arbitrary time point t, and I denotes a unit matrix.

5. The method according to claim 2, wherein the N-th learning data is an N-th real image, and in this case, the second noise addition method is a noise addition method that has a direct correlation with a previous time (Timestep) according to Equation 2 shown below, Equation 2: q(xₜ|xₜ₋₁)= [symbol] (xₜ; \sqrt{1−βₜ}xₜ₋₁, βₜI), wherein xₜ denotes the N-th real image added with noise at an arbitrary time point t, xₜ₋₁ denotes the N-th real image added with noise at t−1, which is a time point immediately before the arbitrary time point t, βₜ denotes a noise schedule at an arbitrary time point t, and I denotes a unit matrix.

6. The method according to claim 2, wherein the N-th learning data is an N-th real image, and in this case, the third noise addition method is a noise addition method that has a direct correlation with a previous time (Timestep) according to Equation 3 shown below, Equation 3: q(xₜ|xₜ₋₁):= [symbol] (xₜ; \sqrt{1−β}βₜxₜ₋₁, 0), wherein xₜ denotes the N-th real image added with noise at an arbitrary time point t, xₜ₋₁ denotes the N-th real image added with noise at t−1, which is a time point immediately before the arbitrary time point t, βₜ denotes a noise schedule at an arbitrary time point t, and I denotes a unit matrix.

7. The method according to claim 2, wherein the N-th learning data is an N-th real image, and in this case, the fourth noise addition method is a noise addition method that has a direct correlation with a previous time (Timestep) according to Equation 4 shown below,
$${q}_{σ} ( {x}_{t - 1} \vert {x}_{t} , {x}_{0} ) = 𝒩 ( \sqrt{{α}_{t - 1}} {x}_{0} + \sqrt{1 - {α}_{t - 1} - {σ}_{t}^{2}} \cdot \frac{{x}_{t} - \sqrt{{α}_{t}} {x}_{0}}{\sqrt{1 - {α}_{t}}} , {σ}_{t}^{2} I ) , \qquad Equation 4$$
wherein xₜ₋₁ denotes the N-th real image added with noise at t−1, which is a time point immediately before an arbitrary time point t, xₜ denotes the N-th real image added with noise at an arbitrary time point t, x₀ denotes the N-th real image of an initial state before noise is added, αₜ=1−βₜ, α̅ₜ: Πₛ₌₁^{t}αₛ, βₜ denotes a noise schedule at an arbitrary time point t, σ is a standard deviation set at each time t, and I denotes a unit matrix.

8. The method according to claim 2, wherein the N-th learning data is an N-th real image, and in this case, step (a-2) includes the steps of:
(a-2-1) inputting the generated N′-th learning data into the image generation model;
(a-2-2) inputting N-th input condition data, which is obtained by adding noise to an N-th condition image frame corresponding to the N-th real image through any one among the first to fourth noise addition methods, into the image generation model; and
(a-2-3) predicting noise applied to the N′-th learning data by reflecting the input N-th input condition data.

9. The method according to claim 2, wherein step (b) includes the steps of:
(b-1) randomly generating noise data of a size the same as that of the semantic image desired to be generated, and inputting the noise data into the image generation model as input data; and
(b-2) generating input condition data by adding noise to a condition image frame for generating a semantic image through any one of the first to fourth noise addition methods, and inputting the input condition data into the image generation model.

10. The method according to claim 1, wherein the image generation model includes an encoder unit and a decoder unit, and further includes a condition image frame utilization unit including one or more convolution layers that acquire feature values from the condition image frame and calculate a scale value and a bias value by passing the feature values, wherein the calculated scale value and bias value are acquired from the input data, and input into the batch normalized feature values to be calculated.

11. An apparatus for generating semantic images using condition image diffusion, the apparatus comprising:
one or more processors;
a network interface;
a memory for loading a computer program executed by the processors; and
a storage for storing large-capacity network data and the computer program, wherein
the computer program executes (A) an operation of training an image generation model by inputting N-th learning data (N is a random positive integer), (B) an operation of inputting input data for generating semantic images into the trained image generation model, and (C) an operation of outputting one or more semantic images generated by the image generation model according to the input data, by the one or more processors, wherein
the input data includes a condition image frame (Layout), which is input condition data, and through the condition image frame, classes, which are one or more objects included in a semantic image to be generated, are classified into each category by the object, and a different number is assigned to pixel areas occupied by the classes for each classified category.

12. A computer program stored in a computer-readable medium, the program for executing the steps of:
(AA) training the image generation model by inputting N-th learning data (N is a random positive integer);
(BB) inputting input data for generating semantic images into the trained image generation model; and
(CC) outputting one or more semantic images generated by the image generation model according to the input data, in combination with a computing device, wherein
the input data includes a condition image frame (Layout), which is input condition data, and through the condition image frame, classes, which are one or more objects included in a semantic image to be generated, are classified into each category by the object, and a different number is assigned to pixel areas occupied by the classes for each classified category.
